(19) United States
(12) Patent Application Publication
(10) Pub. No.: US 2006/0117967 A1
(43) Pub. Date: Jun. 8, 2006

(54) Shell cracker

(76) Inventors: Eugene Roberts, Middletown, CT (US); Greg Massalski, Southington, CT (US)

Correspondence Address: CANTOR COLBURN, LLP, 55 GRIFFIN ROAD SOUTH, BLOOMFIELD, CT, 06002, US

(21) Appl. No.: 11/190,129

(22) Filed: Jul. 26, 2005

Related U.S. Application Data
(60) Provisional application No. 60/591,501, filed on Jul. 26, 2004.

(51) Int. Cl. A23N 5/00

(52) U.S. Cl. 99/568

(57) ABSTRACT

A shell cracking device is described for applying good mechanical advantage to the shell cracking process. In one embodiment, the shell cracker also includes a base or platter providing food liquid containment, e.g., having sidewalls of sufficient height to prevent spillage, for the shell cracking process. The base may also act as a pressure base for shell cracking and provide support for the cracking assembly.

### CROSS REFERENCE TO RELATED APPLICATIONS

The present application claims priority to U.S. Provisional Patent Application Ser. No. 60/591,501, filed Jul. 26, 2004, the entire contents of which are specifically incorporated herein by reference.

### BACKGROUND

Generally, preparation of certain food requires the cracking or removal of shell components, whether it be, for example, a portion of the shell of a shellfish or the shell of a nut.

Typical conventional cracking devices are hand held cracking devices that apply only a limited amount of mechanical advantage. Oftentimes, the hand held devices are not powerful enough to do the intended job of shell cracking. Such hand held cracking devices may be utilized over a platter as a food preparation surface. Although many platters are available, not all provide good food liquid containment.

What is needed in the art is a shell cracking device that is configured to apply good mechanical advantage to the shell cracking process. What is also needed is a base or platter providing food liquid containment for the shell cracking process. What is also needed is an adjustable shell cracking device.

### SUMMARY

The above described and other problems and disadvantages of the prior art are overcome or alleviated by the presently described shell cracker, which is configured to apply good mechanical advantage to the shell cracking process. In one embodiment, the shell cracker also includes a base or platter providing food liquid containment, e.g., having sidewalls of sufficient height to prevent spillage, for the shell cracking process. The platter may also act as a pressure base for shell cracking and provide support for the cracking assembly.

In another embodiment, the shell cracker includes one or more adjustments permitting selective positioning of the cracker around a base or platter or varying the amount of pressure exerted on the shell. In another embodiment, the shell cracker comprises a platter, an adjustable rail assembly, an adjustable cracking blade assembly, a cracking handle, a tail pusher plate and a tail cutter blade.

The presently described shell cracker advantageously overcomes conventional difficulties encountered when cracking food shells. In additional embodiments, food liquids are completely contained on the food preparation surface.

The presently described shell cracker may be used to crack and/or slice various types of food while containing the food liquids. Without limitation, it may be used to crack lobster and crab shells, nuts and other types of food. In addition to containing food liquids, the water-proof platter can also be used for a multitude of other uses including serving food and drinks, vegetable cutting, etc.

The above-discussed and other features and advantages of the apparatus will be appreciated and understood by those skilled in the art from the following detailed description and drawings.

### BRIEF DESCRIPTION OF THE DRAWINGS

Referring now to the drawings, wherein like elements are numbered alike in the several FIGURES:

FIG. 1 is a perspective view of an exemplary shell cracker;

FIG. 2 is a side view of an exemplary handle;

FIG. 3 is a bottom view of the exemplary handle illustrated in FIG. 3;

FIG. 4 is a top view of an exemplary base;

FIG. 5 is a side cutaway view taken along A-A of the exemplary base of FIG. 4;

FIG. 6 is a side view of the exemplary base of FIG. 4;

FIG. 7 is a bottom view of the exemplary base of FIG. 4;

FIG. 8 is a side view of another exemplary handle;

FIG. 9 is a side cutaway view of another exemplary base; and

FIG. 10 is a side view of another exemplary shell cracker.

### DETAILED DESCRIPTION

The presently described shell cracking device applies good mechanical advantage to the shell cracking process. In one embodiment, the shell cracker also includes a base or platter providing food liquid containment, e.g., having sidewalls of sufficient height to prevent spillage, for the shell cracking process. The platter may also act as a pressure base for shell cracking and provide support for the cracking assembly.

Reference will now be made in detail to exemplary embodiments, examples of which are illustrated in the accompanying drawings.

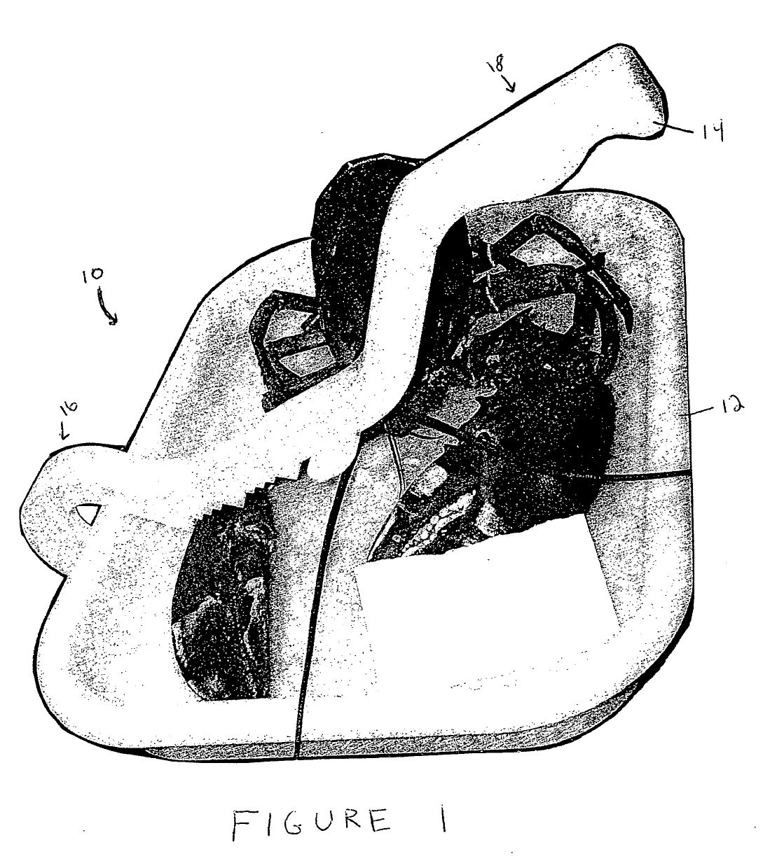

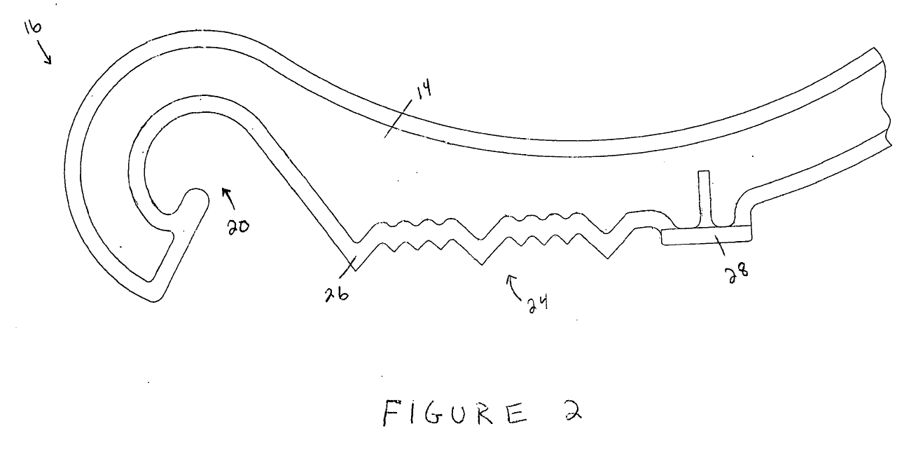

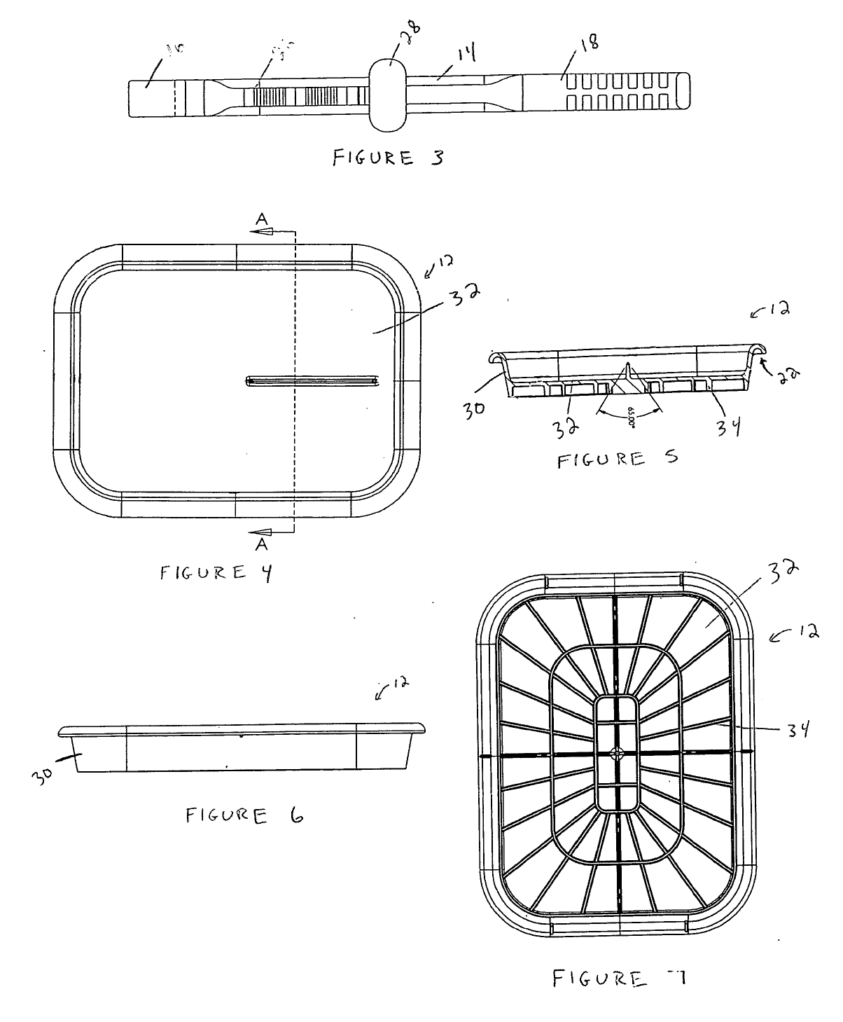

Referring now to FIG. 1, an exemplary shell cracking device is illustrated generally at 10. The shell cracking device comprises a base 12 and a handle 14, which is configured to engage a portion of the base 12.

In the illustrated embodiment, the handle 14 includes a base engaging portion 16 and a grip portion 18 remote from the base engaging portion 16. The grip portin 18 may be smooth or not (e.g., with indentations to facilitate non-slip gripping) or contoured (e.g. ergonomic) or not. The base engaging portion 16 includes a hook portion 20 configured to operatively engage a lip portion (see 22 in FIG. 5) of the base 12. The handle also includes a cracking portion 24, comprising at least one protrusion (in this case, the cracking portion comprises a plurality of protrusions, some of which protrude more than others). The protrusions may be sharp, as illustrated by protrusion 26, or flat, as illustrated by protrusion 28, depending on the type of pressure and/or amount of surface area desired for pressing.

Leverage may be applied by virtue of the operative configuration of the hook portion 20 of the handle 14 and the lip portion 22 of the base. As such, the hook portion 20 is held to the lip 22 during application of downward pressure on the handle, and a user enjoys the benefit of use of the power of the arm and/or the torso in application of such pressure, rather than simply the use of the hand.

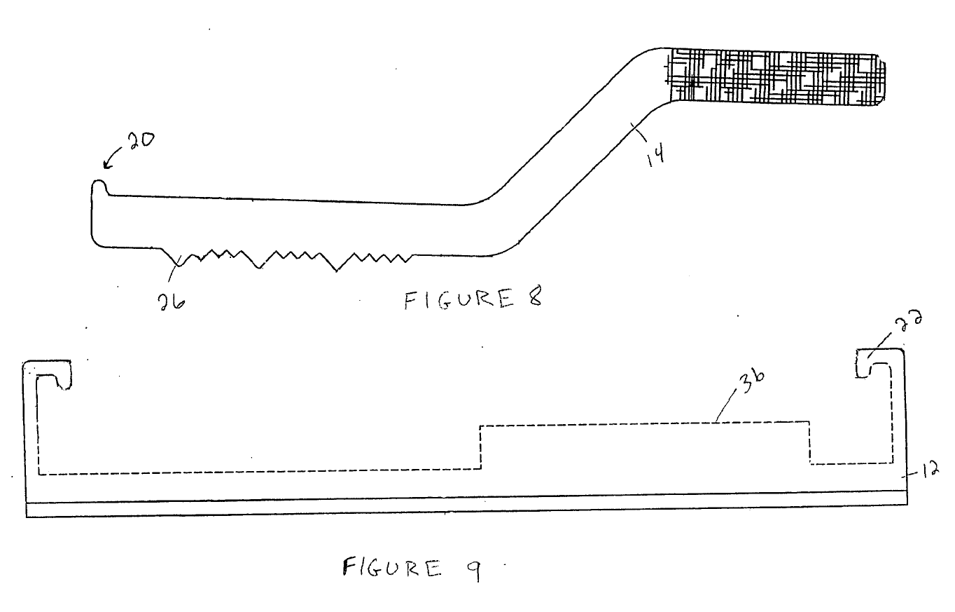

Further, where the lip portion 22 extends around a length of the base 12, as illustrated in the exemplary embodiments at FIGS. 4-7, the hook portion may be positioned at any portion of that length for application to different materials (e.g., different parts of a lobster). Thus, the handle may be positioned where desired, eliminating the need to reposition the material to be cracked in the base.

Referring now to FIGS. 4-7, the illustrated exemplary base 12 includes an uninterrupted sidewall 30 surrounding a materials (e.g., lobster) surface 32. This uninterrupted sidewall 30 provides containment of the material, including any liquid that may be present before or subsequent to use of the handle to crack the material. The sidewall 30 culminates in the lip portion 22, which as may be seen in the illustrated exemplary embodiment, extends entirely around the side wall (thus assuring that the handle may be positioned anywhere around the base). The illustrated base 12 also includes reinforcing ribbing 34 on an underside of the materials surface 32 to prevent buckling or fracturing of the materials surface 32 during application of the handle 14 to the materials.

Referring specifically to FIGS. 4 and 5, the illustrated exemplary embodiment also includes a sharp ridge (or blade) portion 36. This ridge portion 36 may be integral with the materials surface 32, or it may be removable (e.g., a blade received in a slot). The illustrated positioning of the ridge portion 36 finds particular advantage for consumption of lobsters. It is evident upon review of the FIGURES that the positioning of the ridge portion 36 central relative to a long axis of the base, and offset to one side relative to the base short axis places the ridge portion 36 in an ideal position to cut the tail of the lobster upon application of pressure on the top of the lobster tail (e.g., by pressing it with a flat protrusion 28).

It should be noted, however, that such ridge portion 36 may be positioned anywhere desired on the materials surface 32, or indeed, not included at all. Also, the ridge portion may take any shape (including essentially a nail shape) and may be configured with any type of contouring. In the illustrated embodiments, the ridge comprises a long blade having smooth contouring along its length, the blade having an angle of incidence of 65 degrees (see FIG. 5). This is entirely variable according to the needs of the shell cracker.

Accordingly, the above described exemplary embodiments provide a shell cracking device comprising handle and base portions operatively associated such that the handle portion gains leverage from the base portion upon application of pressure on the handle portion towards the base portion. Relative to prior art hand cracking devices, this configuration advantageously provides significantly increased leverage ability and stability.

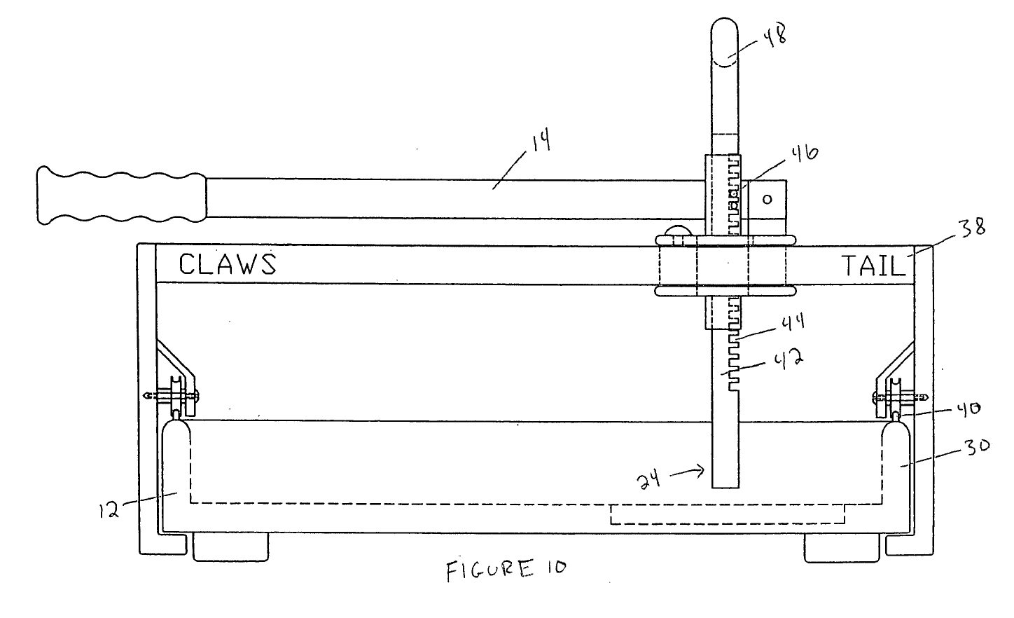

Referring now to FIGS. 8 and 9, another exemplary embodiment includes a handle with a different type of hook portion 20, configured to engage a different base lip 22 construction.

It should be noted that operative association need not require the handle and the base to directly contact (i.e., one or more intermediate parts may be between the base and the handle) as long as the base (or part itself opertively associated with the base) provides leverage support upon application of pressure on the handle towards the base (e.g., against a lobster between the base and the handle).

Referring now to FIG. 10, an exemplary embodiment includes a base 12 itself including an adjustable railing 38. The railing 38 is configured to roll along a track 40 on a sidewall 30 of the base 12. In the exemplary embodiment, the handle 14 is also configured to slide along the railing 38. The handle includes attached thereto an adjustable cracking blade 42 having notches 44 into which pins 46 on the handle 14 are received. This blade may be adjusted to the desired height and locked in place (e.g., by rotating the cracking blade 42 to lock the pins 46 into the notches 44). Such embodiment provides particularly good adjustability by providing the ability to adjust: the position of the rail along the base; the position of the handle along the rail (e.g., to adjust for various sized lobsters); and the height of the cracking blade relative to the base.

The operation of the exemplary embodiment illustrated at FIG. 10 is as follows. The adjustable cracking blade 42 is positioned by moving it manually in a two dimensional plane to the desired position over the food shell. Once in the desired position, the cracking handle 14 is raised to a position approximately 45 degrees above the rails. With the adjustable cracking blade handle 48 in a position parallel to the rails, it is lowered until the end of the blade contacts the food shell. With the end of the cracking blade 42 contacting the shell, the adjustable blade is locked into position by turning the adjustable cracking blade 42 counter clockwise 90 degrees. A downward force is applied to the cracking handle 14 until the shell is cracked. The user then lifts the cracking handle 14 and moves the unit to the next desired position.

For any of the above exemplary embodiments, the shell cracker may comprises parts made of convenient materials having suitable strength for the application, including without limitation: poly-carbonate plastic; stainless steel or nylon plastic.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A shell cracker, comprising:
a base; and
a handle having a grip portion, a cracking portion and a portion operatively associated with said base, wherein said operative association provides a point of leverage to said handle upon application of pressure on said handle as it is moved towards said base.

2. A shell cracker in accordance with claim 1, wherein said base comprises a materials surface having a sidewall surrounding said materials surface, the sidewalls preventing drainage of fluids therepast.

3. A shell cracker in accordance with claim 1, wherein said base further includes at least one lip portion configured to engage said handle.

4. A shell cracker in accordance with claim 1, wherein said portion operatively associated with said base comprises a protrusion or hook configured to engage a sidewall or lip portion of said base.

5. A shell cracker in accordance with claim 1, wherein said base portion further includes at least one ridge provided theron.

6. A shell cracker in accordance with claim 5, wherein said ridge is a blade provided on a materials surface of said base.

7. A shell cracker in accordance with claim 1, wherein said cracking portion comprises a protrusion or contour on said handle.

8. A shell cracker in accordance with claim 7, wherein said cracking portion comprises a plurality of sharp protrusions on said handle.

9. A shell cracker in accordance with claim 8, wherein at least one of said protrusions protrudes more prominently than another protrusion.

10. A shell cracker in accordance with claim 7, wherein said cracking portion comprises a flat area configured to apply even pressure to a material.

11. A shell cracker in accordance with claim 1, wherein said base comprises a materials surface reinforced with structural ribbing.

12. A shell cracker in accordance with claim 1, wherein said shell cracker further comprises a railing provided between and operatively associated with said handle and said base, and wherein said handle is operatively associated with said railing.

13. A shell cracker in accordance with claim 12, wherein said handle is adjustable along a length of said railing.

14. A shell cracker in accordance with claim 12, wherein said railing is adjustable along a track provided on sidewalls of said base.

15. A shell cracker in accordance with claim 12, wherein said cracking portion comprises a cracking blade operatively associated with said handle.

16. A shell cracker in accordance with claim 15, wherein said cracking blade selectively engages said handle in a pin-in-notch configuration.

17. A shell cracker in accordance with claim 16, wherein said cracking blade may be adjusted relative to said handle by virtue of a plurality of said notches.
